(19) United States
(12) Patent Application Publication
(10) Pub. No.: US 2023/0398660 A1
(43) Pub. Date: Dec. 14, 2023

(54) DIRECT-DRIVE DOUBLE-ENDED SLEEVE

(71) Applicant: GUOCHANG COLD FORGING CO., LTD., Taichung City (TW)

(72) Inventor: Hsueh-Jen CHU, Taichung City (TW)

(21) Appl. No.: 17/826,135

(22) Filed: May 26, 2022

(51) Int. Cl. B25B 13/06; B25B 23/00

(52) U.S. Cl. CPC B25B 13/06; B25B 23/0035

(57) ABSTRACT

A direct-drive double-ended sleeve includes: the double-ended sleeve including a first operation hole, a sliding hole, and a second operation hole that are connected in sequence, a direction extending along the first operation hole to the second operation hole being defined as a transverse direction, a middle inner surface surrounding the sliding hole, and a first annular groove being recessed in the middle inner surface; a fastener disposed in the first annular groove; a sliding rod slidably disposed in the double-ended sleeve and moveable along the transverse direction, the sliding rod including a connecting hole, when the sliding rod is located in the double-ended sleeve, the connecting hole penetrates along the transverse direction, the sliding rod includes an outer peripheral surface, the outer peripheral surface includes a first fixing portion and a second fixing portion which are arranged along the transverse direction to engage with the fastener.

### BACKGROUND

### Field of the Invention

The present invention relates to hand tools, and more particularly to a direct-drive double-ended sleeve.

### Description of Related Art

Please refer to the Taiwan Patent Publication No. 200743552, which mainly discloses a double-ended sleeve, and the double-ended sleeve includes a first and a second operation holes of two different sizes at the same time. In this way, the same double-ended sleeve is suitable for locking or loosening bolts of two different specifications, which can effectively reduce the number of sockets the user needs to use, so the sleeve will not excessively occupy the space of the tool box, and can be easily stored by the user.

In use, the aforementioned double-ended sleeve needs to be additionally matched with a connecting rod, one end of the connecting rod is connected to the square hole in the center of the double-ended sleeve, and the other end of the connecting rod is used to connect a pneumatic wrench or a manual wrench. The connecting rod is driven by the pneumatic or manual wrench, and the double-ended sleeve is driven by the connecting rod to rotate. The double-ended sleeve of the aforementioned structure needs to be used with a connecting rod. The connecting rod is often lost, when it comes to storage, which makes the whole set of double-ended sleeves unusable. Although the connecting rod can be purchased separately, the loss of the connecting rod still causes many inconveniences. In view of this, it is indeed necessary to provide a technical means to solve the aforementioned problems.

### SUMMARY

The objective of the invention is to solve the problem that the conventional double-ended sleeve must be used with the connecting rod, and the connecting rod is often lost, when it comes to storage, which makes the whole set of double-ended sleeves unusable.

To achieve the above objective, the present invention provides a direct-drive double-ended sleeve, which comprises:

the double-ended sleeve including a first operation hole, a sliding hole, and a second operation hole that are connected in sequence, a direction extending along the first operation hole to the second operation hole being defined as a transverse direction, the double-ended sleeve including a middle inner surface surrounding the sliding hole, and a first annular groove being recessed in the middle inner surface;

a fastener disposed in the first annular groove;

a sliding rod slidably disposed in the double-ended sleeve and moveable along the transverse direction, the sliding rod including a connecting hole, when the sliding rod is located in the double-ended sleeve, the connecting hole penetrates along the transverse direction, the sliding rod includes an outer peripheral surface, the outer peripheral surface includes a first fixing portion and a second fixing portion which are arranged along the transverse direction to engage with the fastener.

In a preferred embodiment, the fastener is a buckle.

In a preferred embodiment, the first fixing portion is closer to the first operation hole than the second fixing portion, the second fixing portion is closer to the second operation hole than the first fixing portion, the first fixing portion includes a first inclined section and a first upright section, the second fixing section includes a second inclined section and a second upright section, the first upright section is closer to the first operation hole than the first inclined section, the second upright section is closer to the second operation hole than the second inclined section, the closer a part of the first inclined section is to the first operation hole, the longer a diameter of this part of the first inclined section is, and the closer a part of the second inclined section is to the second operation hole, the longer a diameter of this part of the second inclined section is, the first upright section is connected to one end of the first inclined section where the diameter of the first inclined section is the shortest and a diameter of the first upright section is equal to a diameter of the sliding rod, and the second upright section is connected to one end of the second inclined section where the diameter of the second inclined section is the shortest and a diameter of the second upright section is equal to the diameter of the sliding rod.

In a preferred embodiment, the double-ended sleeve includes a sliding section corresponding to the sliding hole, a diameter of the sliding hole is smaller than a diameter of the first operation hole, so that the sliding section includes an abutting surface facing towards the first operation hole, the sliding rod includes a head, when the sliding rod is disposed in the double-ended sleeve, the head is located inside the first operation hole, and the head includes a securing surface abutting against the abutting surface.

Since the sliding rod cooperates with the fastener through the first fixing portion and the second fixing portion, the sliding rod can slide in the double-ended sleeve without falling off. In addition, the first operation hole or the second operation hole can be selectively used in use, so as to solve the problem that the conventional double-ended sleeve must be used with the connecting rod, and the connecting rod is often lost, when it comes to storage, which makes the whole set of double-ended sleeves unusable.

### BRIEF DESCRIPTION OF THE DRAWINGS

FIG. 1 is an exploded perspective view of the present invention in a preferred embodiment;

FIG. 2 is a side cross-sectional view of the combination of the second fixing portion of the sliding rod and the fastener;

FIG. 3 is a side cross-sectional view of the combination of the first fixing portion of the sliding rod and the fastener;

FIG. 4 is a side sectional view of the present invention in a second embodiment;

FIG. 5 is a side cross-sectional view of the combination of the second fixing portion of the sliding rod and the fastener in another embodiment of the present invention; and

FIG. 6 is a side cross-sectional view of the combination of the first fixing portion of the sliding rod and the fastener in another embodiment of the present invention.

### DETAILED DESCRIPTION

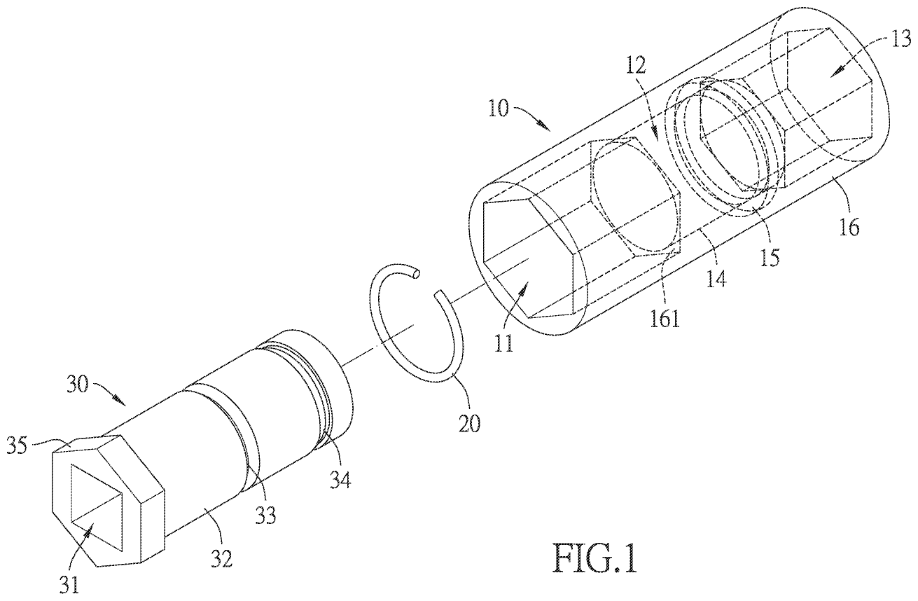

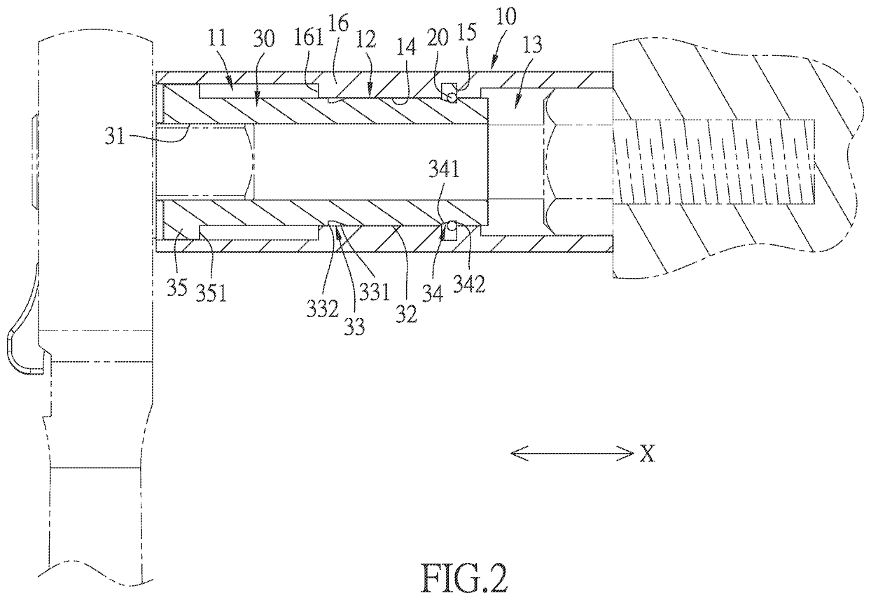

Please refer to FIG. 1 and FIG. 2, the present invention is a direct-drive double-ended sleeve, which essentially comprises a double-ended sleeve 10, a fastener 20 and a sliding rod 30.

The double-ended sleeve 10 includes a first operation hole 11, a sliding hole 12, and a second operation hole 13 that are connected in sequence. A direction extending along the first operation hole 11 to the second operation hole 13 is defined as a transverse direction X. The double-ended sleeve 10 includes a middle inner surface 14 surrounding the sliding hole 12, and a first annular groove 15 is recessed in the middle inner surface 14. In this embodiment, the first operation hole 11 and the second operation hole 13 of the double-ended sleeve 10 are different in size, so that they can be used for locking or releasing bolts of two different specifications.

The fastener 20 is disposed in the first annular groove 15; in this embodiment, the fastener 20 is a buckle to fasten an object to prevent it from moving and loosening.

The sliding rod 30 is slidably disposed in the double-ended sleeve 10 and moveable along the transverse direction X, and the sliding rod 30 includes a connecting hole 31. When the sliding rod 30 is located in the double-ended sleeve 10, the connecting hole 31 penetrates along the transverse direction X, and the sliding rod 30 includes an outer peripheral surface 32, and the outer peripheral surface 32 of the sliding rod 30 includes a first fixing portion 33 and a second fixing portion 34 which are arranged along the transverse direction X to engage with the fastener 20. In this embodiment, the first fixing portion 33 and the second fixing portion 34 are all annular recessed grooves. When the sliding rod 30 slides along the transverse direction X in the double-ended sleeve 10, the fastener 20 is engaged in the first fixing portion 33 or the second fixing portion 34, which can prevent the sliding rod from being separated from the double-ended sleeve 10.

In this embodiment, the first fixing portion 33 is closer to the first operation hole 11 than the second fixing portion 34, and the second fixing portion 34 is closer to the second operation hole 13 than the first fixing portion 33. The first fixing portion 33 includes a first inclined section 331 and a first upright section 332, and the second fixing section 34 includes a second inclined section 341 and a second upright section 342. The first upright section 332 is closer to the first operation hole 11 than the first inclined section 331, and the second upright section 342 is closer to the second operation hole 13 than the second inclined section 341. The closer a part of a first inclined section 331 is to the first operation hole 11, the shorter a diameter of this part of the first inclined section 331 is, and the closer a part of the second inclined section 341 is to the second operation hole 13, the shorter a diameter of this part of the second inclined section 341 is. The first upright section 332 is connected to one end of the first inclined section 331 where the diameter of the first inclined section 331 is the shortest, and a diameter of the first upright section 332 is equal to the diameter of the sliding rod 30. The second upright section 342 is connected to one end of the second inclined section 341 where the diameter of the second inclined section 341 is the shortest, and a diameter of the second upright section 342 is equal to the diameter of the sliding rod 30. Therefore, when the sliding rod 30 slides and the fastener 20 falls into the first fixing portion 33 or the second fixing portion 34, the fastener 20 will slide into the first fixing portion 33 or the second fixing portion 34 through the inclined first inclined section 331 or the second inclined portion 341, and the fastener 20 is stopped by the first upright portion 332 or the second upright portion 342, thereby preventing the sliding rod 30 from disengaging from the double-ended sleeve 10.

Secondly, the double-ended sleeve 10 includes a sliding section 16 corresponding to the sliding hole 12. Since the diameter of the sliding hole 12 is smaller than the diameter of the first operation hole 11, the sliding section 16 has an abutting surface 161 facing towards the first operation hole 11, the sliding rod 30 includes a head 35. When the sliding rod 30 is disposed in the double-ended sleeve 10, the head 35 is located inside the first operation hole 11, and the head 35 includes a securing surface 351 abutting against the abutting surface 161, the abutting surface 161 and the securing surface 351 cooperate and abut against each other to prevent the sliding rod 30 from detaching from the second operation hole 13.

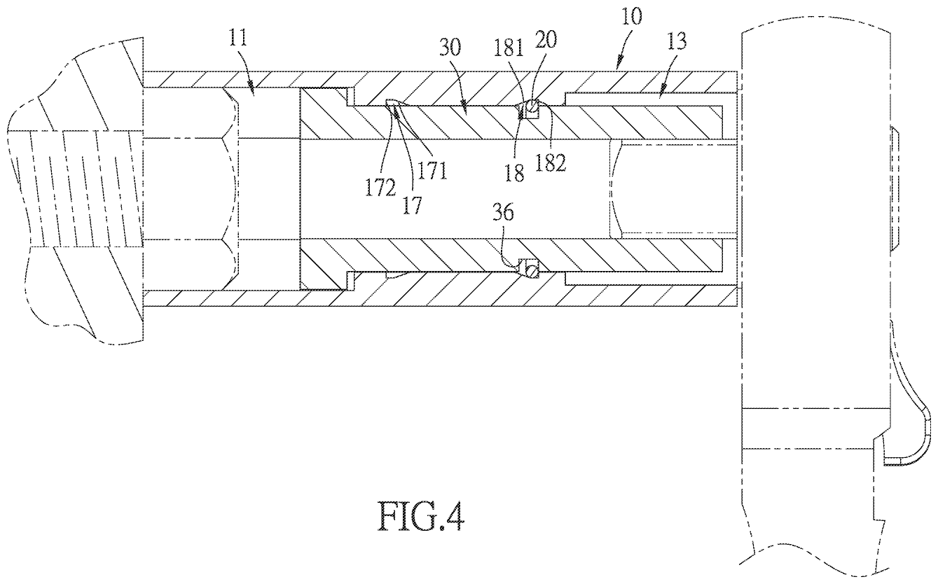

Please refer to FIG. 4, in a second embodiment of the present invention, the double-ended sleeve 10 is not provided with the first annular groove 15, and the sliding rod 30 does not includes the first fixing portion 33 and the second fixing portion 34. The sliding rod 30 includes a second annular groove 36 formed on an outer peripheral surface thereof, and the fastener 20 is engaged in the second annular groove 36. The double-ended sleeve 10 includes a third fixing portion 17 and a fourth fixing portion 18 arranged along the transverse direction X. The third fixing portion 17 is closer to the first operation hole 11 than the fourth fixing portion 18, and the fourth fixing portion 18 is closer to the second operation hole 13 than the third fixing portion 17. The third fixing portion 17 includes a third inclined section 171 and a third upright section 172, and the fourth fixing portion 18 includes a fourth inclined section 181 and a fourth upright section 182. The third upright section 172 is closer to the first operation hole 11 than the third inclined section 171, and the fourth upright section 182 is closer to the second operation hole 13 than the fourth inclined section 181. The closer a part of the third inclined section 171 is to the first operation hole 11, the shorter a diameter of this part of the third inclined section 17 is, and the closer a part of the fourth inclined section 181 is to the second operation hole 13, the shorter a diameter of this part of the fourth inclined section 181 is. The third upright section 172 is connected to one end of the third inclined section 171 where the diameter of the third inclined section 171 is the shortest, and a diameter of the third upright section 172 is equal to the diameter of the sliding rod 30, and the fourth upright section 182 is connected to one end of the fourth inclined section 181 where the diameter of the fourth inclined section 181 is the shortest, and a diameter of the fourth upright section 182 is equal to the diameter of the sliding rod 30. Therefore, when the sliding rod 30 slides to allow the fastener 20 to fall into the third fixing portion 17 or the fourth fixing portion 18, the fastener 20 will slide into the third fixing portion 17 or the fourth fixing portion 18 via the third inclined section 171 or the fourth inclined section 182, and the fastener 20 will be stopped by the third upright section 172 or the fourth upright section 182 to prevent the sliding rod 30 from disengaging from the double-ended sleeve 10.

The above is the structure configuration and the connection relationship of the present invention in a preferred embodiment, the use mode of the present invention and the effects that can be produced are as follows:

Please refer to FIG. 2, when the user wants to drive the double-ended sleeve 10 from the first operation hole 11 and use the second operation hole 13 to lock a bolt or nut, he/she can push the sliding rod 30 to move toward the first operation hole 11, and then the fastener 20 is locked into the second fixing portion 34, and after the fastener 20 is abutted against the second upright section 342, the fastener 20 can't move arbitrarily in the double-ended sleeve 10. At this time, the user can fix the wrench to the connecting hole 31 of the sliding rod located in the first operation hole 11, and fix the bolt in the second operation hole 13, and then drive the bolt to rotate by rotating the wrench.

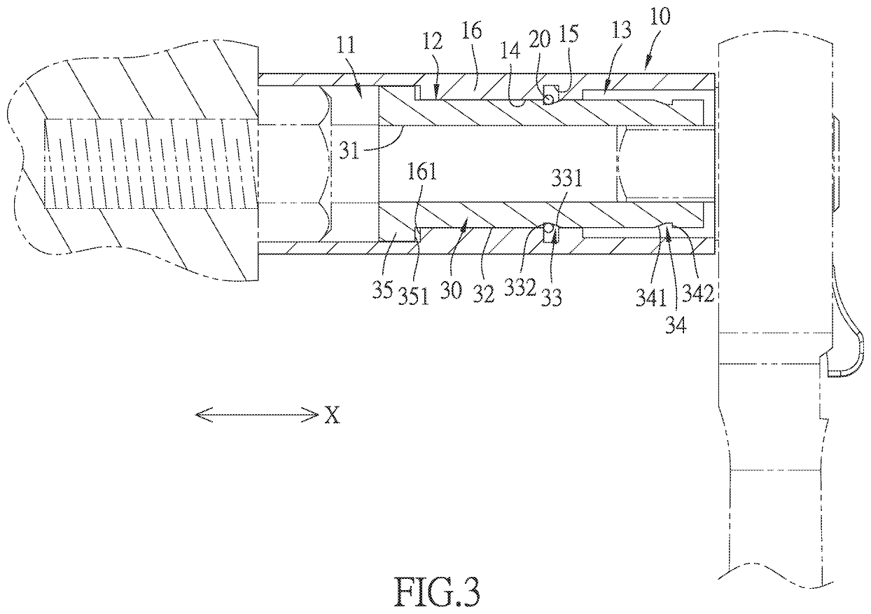

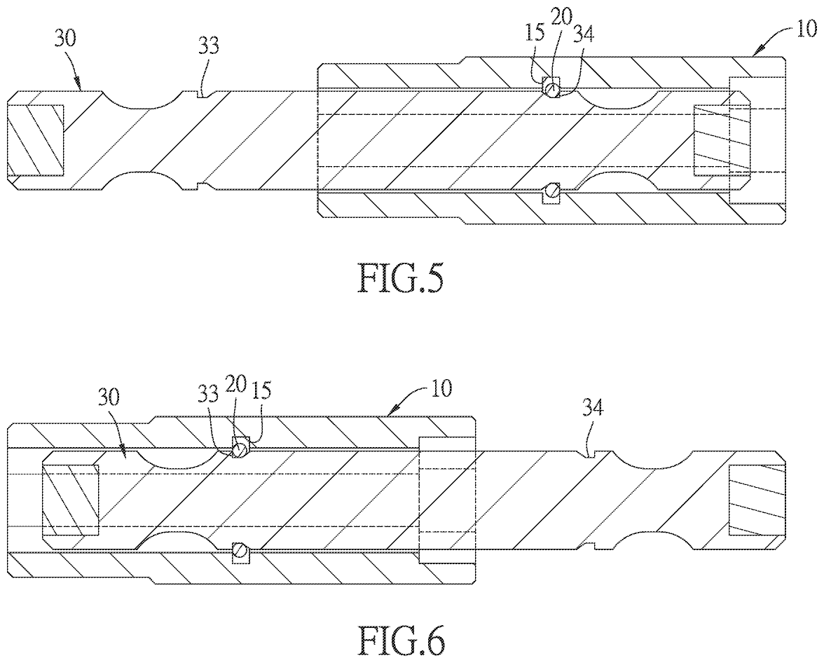

Please refer to FIG. 3, when the user wants to drive the double-ended sleeve 10 from the second operation hole 13, and use the first operation hole 11 to lock a bolt (or nut), he/she can push the sliding rod 30 to move from the first operation hole 11 along the transverse direction X toward the second operation hole 13, so that the fastener 20 is separated from the second fixing portion 34. When the first fixing portion 33 of the sliding rod 30 is aligned with the fastener 20, the fastener 20 will be moved along the first inclined section 331 until it is stopped against the first upright section 332. More preferably, the securing surface 351 of the head 35 and the abutting surface 161 can be abutted against each other to prevent the sliding rod 30 from being detached from the position of the second operation hole 13, so that the user can fix the wrench in the connecting hole 31 of the sliding rod in the second operation hole 13, fix the bolt or nut in the first operation hole 11, and then drive the bolt or nut to rotate by rotating the wrench. Please refer to FIGS. 5 and 6, the length of the sliding rod 30 is not limited to be shorter than that of the double-ended sleeve 10. In another embodiment, the length of the sliding rod 30 is longer than that of the double-ended sleeve 10, and can still be used in the same manner as mentioned above.

Since the sliding rod 30 cooperates with the fastener 20 through the first fixing portion 33 and the second fixing portion 34, the sliding rod 30 can slide in the double-ended sleeve 10 without falling off. In addition, the first operation hole 11 or the second operation hole 13 can be selectively used in use, so as to solve the problem that the conventional double-ended sleeve 10 must be used with the connecting rod, and the connecting rod is often lost, when it comes to storage, which makes the whole set of double-ended sleeves unusable.

What is claimed is:

1. A direct-drive double-ended sleeve, comprising:
the double-ended sleeve including a first operation hole, a sliding hole, and a second operation hole that are connected in sequence, a direction extending along the first operation hole to the second operation hole being defined as a transverse direction, the double-ended sleeve including a middle inner surface surrounding the sliding hole, and a first annular groove being recessed in the middle inner surface;
a fastener disposed in the first annular groove;
a sliding rod slidably disposed in the double-ended sleeve and moveable along the transverse direction, the sliding rod including a connecting hole, when the sliding rod is located in the double-ended sleeve, the connecting hole penetrates along the transverse direction, the sliding rod includes an outer peripheral surface, the outer peripheral surface includes a first fixing portion and a second fixing portion which are arranged along the transverse direction to engage with the fastener.

2. The direct-drive double-ended sleeve as claimed in claim 1, wherein the first fixing portion is closer to the first operation hole than the second fixing portion, the second fixing portion is closer to the second operation hole than the first fixing portion, the first fixing portion includes a first inclined section and a first upright section, the second fixing section includes a second inclined section and a second upright section, the first upright section is closer to the first operation hole than the first inclined section, the second upright section is closer to the second operation hole than the second inclined section, the closer a part of the first inclined section is to the first operation hole, the shorter a diameter of this part of the first inclined section is, and the closer a part of the second inclined section is to the second operation hole, the shorter a diameter of this part of the second inclined section is, the first upright section is connected to one end of the first inclined section where the diameter of the first inclined section is the shortest, a diameter of the first upright section is equal to a diameter of the sliding rod, and the second upright section is connected to one end of the second inclined section where the diameter of the second inclined section is the shortest, and a diameter of the second upright section is equal to the diameter of the sliding rod.

3. The direct-drive double-ended sleeve as claimed in claim 1, wherein the fastener is a buckle.

4. The direct-drive double-ended sleeve as claimed in claim 1, wherein the double-ended sleeve includes a sliding section corresponding to the sliding hole, a diameter of the sliding hole is smaller than a diameter of the first operation hole, so that the sliding section includes an abutting surface facing towards the first operation hole, the sliding rod includes a head, when the sliding rod is disposed in the double-ended sleeve, the head is located inside the first operation hole, and the head includes a securing surface abutting against the abutting surface.

5. A direct-drive double-ended sleeve, comprising:
the double-ended sleeve including a first operation hole, a sliding hole, and a second operation hole that are connected in sequence, a direction extending along the first operation hole to the second operation hole being defined as a transverse direction, the double-ended sleeve including a middle inner surface surrounding the sliding hole, and a third fixing portion and a fourth fixing portion being formed on the middle inner surface and arranged along the transverse direction;
a sliding rod slidably disposed in the double-ended sleeve and moveable along the transverse direction, the sliding rod including a connecting hole, when the sliding rod is located in the double-ended sleeve, the connecting hole penetrates along the transverse direction, the sliding rod includes an outer peripheral surface, the outer peripheral surface includes a second annular groove; and
a fastener disposed in the second annular groove to engage with the third fixing portion and the fourth fixing portion.

6. The direct-drive double-ended sleeve as claimed in claim 5, wherein the fastener is a buckle.

7. The direct-drive double-ended sleeve as claimed in claim 5, wherein the third fixing portion is closer to the first operation hole than the fourth fixing portion, the fourth fixing portion is closer to the second operation hole than the third fixing portion, the third fixing portion includes a third inclined section and a third upright section, the fourth fixing portion includes a fourth inclined section and a fourth upright section, the third upright section is closer to the first operation hole than the third inclined section, the fourth upright section is closer to the second operation hole than the fourth inclined section, the closer a part of the third inclined section is to the first operation hole, the longer a diameter of this part of the third inclined section is, the closer a part of the fourth inclined section is to the second operation hole, the longer a diameter of this part of the fourth inclined section is, the third upright section is connected to one of the third inclined section where the diameter of the third inclined section is the shortest, a diameter of the third upright section is equal to a diameter of the sliding rod, and the fourth upright section is connected to one of the fourth inclined section where the diameter of the fourth inclined section is the shortest, and a diameter of the fourth upright section is equal to the diameter of the sliding rod.

8. The direct-drive double-ended sleeve as claimed in claim 5, wherein the double-ended sleeve includes a sliding section corresponding to the sliding hole, a diameter of the sliding hole is smaller than a diameter of the first operation hole, so that the sliding section includes an abutting surface facing towards the first operation hole, the sliding rod includes a head, when the sliding rod is disposed in the double-ended sleeve, the head is located inside the first operation hole, and the head includes a securing surface abutting against the abutting surface.
